(19) United States
(12) Patent Application Publication
(10) Pub. No.: US 2026/0292548 A1
(43) Pub. Date: Sep. 24, 2026

(54) UPLINK SPECTRUM ANALYSIS OVER OPEN FRONTHAUL NETWORKS

(71) Applicant: VIAVI Solutions Inc., Chandler, AZ (US)

(72) Inventors: Reza VAEZ-GHAEMI, Potomac, MD (US); James Gordon BEATTIE, Jr., Live Oak, FL (US); Sung-Hwa IM, Siheung-si (KR); Paul HARRIS, Havant (GB); Wei CHEN, Potomac, MD (US)

(21) Appl. No.: 19/087,890

(22) Filed: Mar. 24, 2025

(51) Int. Cl. H04W 24/08; H04W 72/0446; H04W 72/0453

(52) U.S. Cl. CPC H04W 24/08; H04W 72/0446; H04W 72/0453

(57) ABSTRACT

A method for performing spectral analysis on open fronthaul uplink packets includes transmitting, to an open radio unit (O-RU), a plurality of control plane packets, each control plane packet corresponding to a respective timeslot of a plurality of timeslots; receiving, from the O-RU, a plurality of user plane packets for each respective timeslot, each user plane packet including frequency-domain in-phase and quadrature (IQ) data representative of a respective symbol of a plurality of symbols; combining, for each subcarrier of a plurality of subcarriers and for a predetermined number of radio frames, the frequency-domain IQ data into a single IQ value to derive a plurality of single IQ values for the predetermined number of radio frames, each single IQ value corresponding to a respective subcarrier of the plurality of subcarriers; and displaying, based on the plurality of single IQ values, an uplink spectrum of the O-RU.

### BACKGROUND

A radio frequency (RF) spectrum analyzer is a versatile tool designed to detect, measure, and analyze RF signals across a wide range of industries. An RF spectrum analyzer may be used to detect and identify sources of RF interference and to monitor the health of a wireless system. An RF spectrum analyzer measures the raw RF energy of a transmitted RF signal and can assist a user by providing an image representative of an RF signal or an RF environment.

### SUMMARY

In some implementations, a method for performing spectral analysis on open fronthaul (OFH) uplink (UL) packets of an open radio access network (O-RAN) includes transmitting, to an open radio unit (O-RU), a plurality of control plane packets, wherein each control plane packet of the plurality of control plane packets corresponds to a respective timeslot of a plurality of timeslots; receiving, from the O-RU, a plurality of user plane packets for each respective timeslot, wherein each user plane packet includes frequency-domain in-phase and quadrature (IQ) data representative of a respective symbol of a plurality of symbols; combining, for each subcarrier of a plurality of subcarriers and for a predetermined number of radio frames, the frequency-domain IQ data into a single IQ value to derive a plurality of single IQ values for the predetermined number of radio frames, wherein each single IQ value of the plurality of single IQ values corresponds to a respective subcarrier of the plurality of subcarriers; and displaying, based on the plurality of single IQ values, power levels across a frequency axis for a transmission bandwidth of the O-RU.

In some implementations, a method for performing spectral analysis on OFH UL packets of an O-RAN includes requesting UL spectrum data from an O-RU; receiving the UL spectrum data from the O-RU, wherein the UL spectrum data is mapped into user plane packets, and wherein the UL spectrum data comprises frequency-domain IQ data; performing the spectral analysis using the UL spectrum data, including: for each subcarrier of a plurality of subcarriers, combining the frequency-domain IQ data into a single IQ value to derive a plurality of single IQ values for the plurality of subcarriers; generating, based on the plurality of single IQ values, an image of a real-time UL spectrum of the O-RU; and displaying the image on a display.

In some implementations, an OFH UL spectrum analyzer includes a communication interface configured to communicate with an O-RU, the communication interface configured to: transmit, to the O-RU, a plurality of control plane packets, wherein each control plane packet of the plurality of control plane packets corresponds to a respective timeslot of a plurality of timeslots, and receive, from the O-RU, a plurality of user plane packets for each respective timeslot, wherein each user plane packet includes a pair of IQ values representative of a respective symbol of a plurality of symbols; one or more memories; one or more processors, communicatively coupled to the one or more memories, configured to: combine, for each subcarrier of a plurality of subcarriers and for a predetermined number of radio frames, pairs of IQ values into a single IQ value to derive a plurality of single IQ values for the predetermined number of radio frames, wherein each single IQ value of the plurality of single IQ values corresponds to a respective subcarrier of the plurality of subcarriers, and generate pixel values based on the plurality of single IQ values, the pixel values being representative of power levels across a frequency axis for a transmission bandwidth of the O-RU; and a display configured to display an image of an UL spectrum of the O-RU based on the pixel values.

### BRIEF DESCRIPTION OF THE DRAWINGS

FIG. 1 is a diagram of an example environment in which systems and/or methods described herein may be implemented.

FIG. 2 is a diagram of an example RAN in which systems and/or methods described herein may be implemented.

FIG. 3 is a diagram of a spectral analysis system according to one or more implementations.

FIG. 4 shows an example UL resource grid.

FIG. 5 is a flowchart of an example process associated with uplink spectrum analysis over open fronthaul networks.

FIG. 6 is a flowchart of an example process associated with uplink spectrum analysis over open fronthaul networks.

### DETAILED DESCRIPTION

The following detailed description of example implementations refers to the accompanying drawings. The same reference numbers in different drawings may identify the same or similar elements.

Traditional RF spectrum analyzers cannot perform spectral analysis on open fronthaul (OFH) uplink (UL) packets. Instead, traditional RF spectrum analyzers are only capable of analyzing RF signals emitted by a radio antenna or RF signals present in the environment from another RF source.

Some implementations described herein are directed to an UL spectrum analyzer configured to perform spectral analysis on an UL signal by decoding OFH UL packets. For example, the UL spectrum analyzer may leverage IQ mapping methods used in an OFH network to perform the spectral analysis. In some implementations, the UL spectrum analyzer may extract and decode frequency-domain IQ data that is embedded in the OFH UL packets that are transmitted by an O-RU on an UL communication link.

The UL spectrum analyzer may be configured to emulate an open distributed unit (O-DU) for receiving UL data from O-RU. For example, the UL spectrum analyzer may emulate the O-DU by transmitting management plane and control plane messages (e.g., packets) to the O-RU and receiving user plane messages (e.g., packets) from the O-RU in response to the management plane and control plane messages. Thus, the UL spectrum analyzer may request UL data from the O-RU. The UL data may contain UL spectrum data (e.g., frequency-domain IQ data) mapped into user plane packets. The UL spectrum analyzer may use the UL spectrum data to perform a real-time spectral analysis of the UL signal.

In some implementations, the UL spectrum analyzer may retrieve the frequency-domain IQ data from the user plane packets, and generate an UL spectrum for display based on the frequency-domain IQ data. A user of the UL spectrum analyzer may inspect the UL spectrum to determine a presence of any interferers or active/passive intermodulation.

The UL spectrum analyzer may require all symbols (e.g., of all resource blocks (RBs) and resource elements (REs) in all requested timeslots) to be received in order to perform the real-time spectral analysis. Additionally, since the UL spectrum data is in the frequency-domain, using a fast Fourier transform (FFT) is not needed, which may enable real-time analysis of the UL spectrum. Here, the O-RU may convert time-domain IQ data into frequency-domain IQ data prior to sending the frequency-domain IQ data to the UL spectrum analyzer. A spectrum bandwidth may be equal to a total quantity of RBs.

In some implementations, the UL spectrum analyzer may initialize the O-RU with O-RAN management plane messages. In addition, the UL spectrum analyzer may periodically send control plane messages to the O-RU, on a per timeslot basis, to configure the O-RU to send all RBs and symbols within each timeslot on the UL communication link. For example, the O-RU may send user plane packets for each timeslot requested by the UL spectrum analyzer. Each user plane packet may contain, as frequency-domain IQ data, a pair of IQ values in the frequency-domain. A pair of IQ values may be representative of a symbol. Thus, the UL spectrum analyzer may receive all pairs of IQ values (e.g., all symbols) for all RBs within each timeslot. The UL spectrum analyzer may extract the pairs of IQ values from all user plane packets, representing all symbols within the requested timeslots, and generate a real-time spectrum using amplitudes calculated from the pairs of IQ values. The amplitudes may be representative of power levels. Thus, the UL spectrum analyzer may display the power levels across a frequency axis within a transmission bandwidth supported by the O-RU.

In some implementations, the UL spectrum analyzer may detect active intermodulation. For example, the UL spectrum analyzer may actively inject one or more continuous wave signals into the O-RU (in a downlink (DL) direction) for detecting active intermodulation. The UL spectrum analyzer may use a control plane message to reserve two or more specific RBs in a DL symbol, may use a user plane message to send two or more continuous wave signals in a specific RE (subcarrier) in specific RBs in the DL symbol, and monitor the UL spectrum for active intermodulation by requesting all UL RBs.

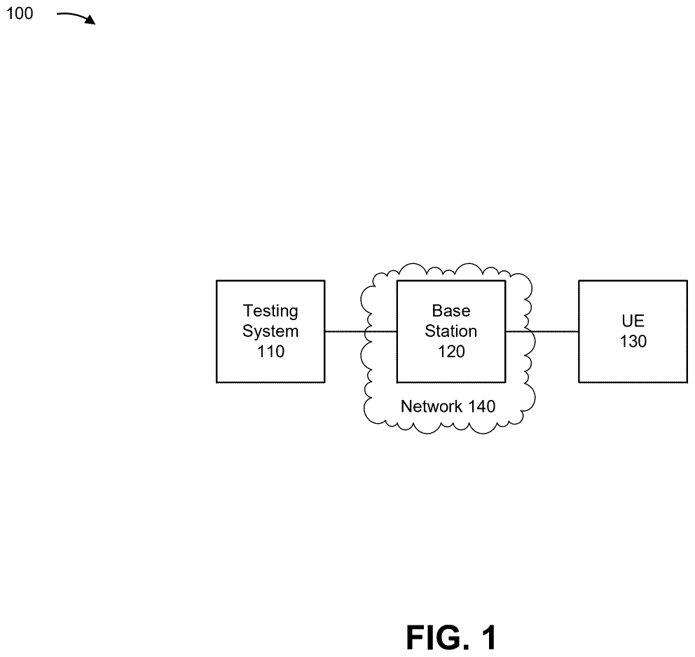

FIG. 1 is a diagram of an example environment 100 in which systems and/or methods described herein may be implemented. As shown in FIG. 1, environment 100 may include a testing system 110, a base station 120, a user equipment (UE) 130, and a network 140. Devices of environment 100 may interconnect via wired connections, wireless connections, or a combination of wired and wireless connections.

Testing system 110 includes one or more devices capable of communicating with base station 120 and/or a network (e.g., network 140), such as to perform processing of a signal produced by base station 120. Testing system 110 may communicate with base station 120 by a wired connection, as described elsewhere herein. In some implementations, testing system 110 may wirelessly communicate with base station 120.

Testing system 110 may include a beamforming network, a feedback component, and/or a test component as described elsewhere herein. The beamforming network may include an analog beamforming network that outputs a signal associated with a beam direction, as described elsewhere herein. The feedback component may include a passive RF component, such as an RF coupler, that outputs a feedback signal based on an output signal of the beamforming network or a calibration signal of a calibration component of the base station 120, as described elsewhere herein. The test component may include one or more devices capable of receiving, generating, storing, processing, and/or providing information associated with a signal, such as an RF signal (e.g., an output signal of the beamforming network). For example, the test component may include a communication and/or computing device, such as a mobile phone (e.g., a smart phone, a radiotelephone, etc.), a laptop computer, a tablet computer, a handheld computer, a desktop computer, a gaming device, a wearable communication device (e.g., a smart wristwatch, a pair of smart eyeglasses, etc.), or a similar type of device.

Base station 120 includes one or more devices capable of communicating with a UE using a cellular radio access technology (RAT). For example, base station 120 may include a base transceiver station, a radio base station, a node B, an evolved node B (eNB), a gNB, a base station subsystem, a cellular site, a cellular tower (e.g., a cell phone tower or a mobile phone tower), an access point, a transmit receive point (TRP), a radio access node, a macrocell base station, a microcell base station, a picocell base station, a femtocell base station, or a similar type of device. Base station 120 may transfer traffic between a UE (e.g., using a cellular RAT), other base stations 120 (e.g., using a wireless interface or a backhaul interface, such as a wired backhaul interface), and/or network 140. Base station 120 may provide one or more cells that cover geographic areas. Some base stations 120 may be mobile base stations. Some radio units may be capable of communicating using multiple RATs.

In some implementations, base station 120 may perform scheduling and/or resource management for UEs covered by base station 120 (e.g., UEs covered by a cell provided by base station 120). In some implementations, base stations 120 may be controlled or coordinated by a network controller, which may perform load balancing and/or network-level configuration. The network controller may communicate with base stations 120 via a wireless or wireline backhaul. In some implementations, base station 120 may include a network controller, a self-organizing network (SON) module or component, or a similar module or component. In other words, a base station 120 may perform network control, scheduling, and/or network management functions (e.g., for other base stations 120 and/or for uplink, downlink, and/or sidelink communications of UEs covered by the base station 120). In some implementations, base station 120 may include a central unit and multiple distributed units. The central unit may coordinate access control and communication with regard to the multiple distributed units. The multiple distributed units may provide UEs and/or other base stations 120 with access to network 140.

In some implementations, base station 120 may be capable of multiple-input, multiple-output (MIMO) communication (e.g., beamformed communication). In some implementations, base station 120 may include a calibration component for phase calibration of signals produced or received by base station 120, as described elsewhere herein. In a testing scenario, one or more antenna elements (e.g., an antenna array) of base station 120 may be disconnected, and base station 120 may be connected to a test panel, as described elsewhere herein.

In a traditional cellular network, the base station 120 may include a radio unit (RU) and a baseband unit (BBU). The RU may handle radio frequency (RF) signal transmission and reception (e.g., RF processing) to and from the UE 130. The RU may be located proximate to, and is coupled to, the one or more antennas. Thus, the RU may receive RF signals from the UE 130 via the one or more antennas, and may transmit RF signals to the UE 130 via the one or more antennas. The RU may convert baseband signals received from the BBU to RF for antenna transmission, and may convert RF signals received from the one or more antennas to baseband for the BBU. In some cases, the RU may be referred to as a remote radio unit (RRU) or a remote radio head (RRH). The BBU may perform baseband processing, including modulation, encoding, and signal processing tasks. Thus, the BBU may process digital radio signals. The BBU may communicate with the RU using a common public radio interface (CPRI). The BBU may take the signal information (e.g., data) received from the RU, and process the signal information to be forwarded to a core network (e.g., including a network controller). Additionally, the BBU may receive signal information from the core network, and process the signal information to be sent to the RU. The BBU may be connected to the core network via one of more fiber optic cables. The core network may perform management functions, including user authentication, mobility management, session and connection management, data routing, and/or policy control, among other examples.

In an open RAN, the base station 120 may be disaggregated into different components with open interfaces. For example, the base station 120 may be disaggregated into an open RU (O-RU), an open distributed unit (O-DU), and an open centralized unit (O-CU). In other words, the BBU may be formed by the O-DU and the O-CU. The O-RU may perform RF-related tasks such as transmitting and receiving signals (e.g., RF processing), beamforming, RF amplification, and antenna control.

The O-DU may handle lower-layer baseband processing, such as the physical (PHY) layer, including error correction and signal modulation/demodulation. The O-DU may implement scheduling, error correction, and/or resource allocation. In some implementations, such as in centralized deployments, the O-DU may manage user traffic and support multiple O-RUs. The O-CU may perform higher-layer processing, such as radio resource management, and may handle network-layer protocols.

The O-DU may operate radio link control and medium access control (MAC) layers in addition to some of the physical layers. Thus, the O-DU may be controlled by the O-CU. The O-CU may operate a radio resource control protocol, which may conduct many functions, including information broadcasting, establishing and releasing connections between the user equipment and the RAN, and controlling a quality of service. The O-CU may also operate with a packet data convergence protocol, which may compress and decompress internet protocol (IP) data stream headers and may transfer user data, among other technical functions.

The O-DU may be connected to the O-RU via a fronthaul communication link (e.g., CPRI or enhanced CPRI (eCPRI)), the O-DU may be connected to the O-CU via a midhaul communication link, and the O-CU may be connected to the core network via a backhaul communication link. In some implementations, the fronthaul communication link, the midhaul communication link, and/or the backhaul communication link may be optical fiber connections.

UE 130 may include one or more devices capable of communicating with base station 120 and/or a network (e.g., network 140). For example, UE 130 may include a wireless communication device, a radiotelephone, a personal communications system (PCS) terminal (e.g., that may combine a cellular radiotelephone with data processing and data communications capabilities), a smart phone, a laptop computer, a tablet computer, a personal gaming system, user equipment, and/or a similar device. UE 130 may be capable of communicating using uplink (e.g., UE to base station) communications, downlink (e.g., base station to UE) communications, and/or sidelink (e.g., UE-to-UE) communications. In some implementations, UE 130 may include a machine-type communication (MTC) UE, such as an evolved or enhanced MTC (eMTC) UE. In some implementations, UE 130 may include an Internet of Things (IoT) UE, such as a narrowband IoT (NB-IoT) UE.

Network 140 includes one or more wired and/or wireless networks. For example, network 140 may include a cellular network (e.g., a long-term evolution (LTE) network, a code division multiple access (CDMA) network, a 3G network, a 4G network, a 5G network, or another type of next generation network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or a combination of these or other types of networks. In some implementations, the network 140 may be a radio area network (RAN). For example, the network 140 may be an open RAN.

The quantity and arrangement of devices and networks shown in FIG. 1 are provided as one or more examples. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

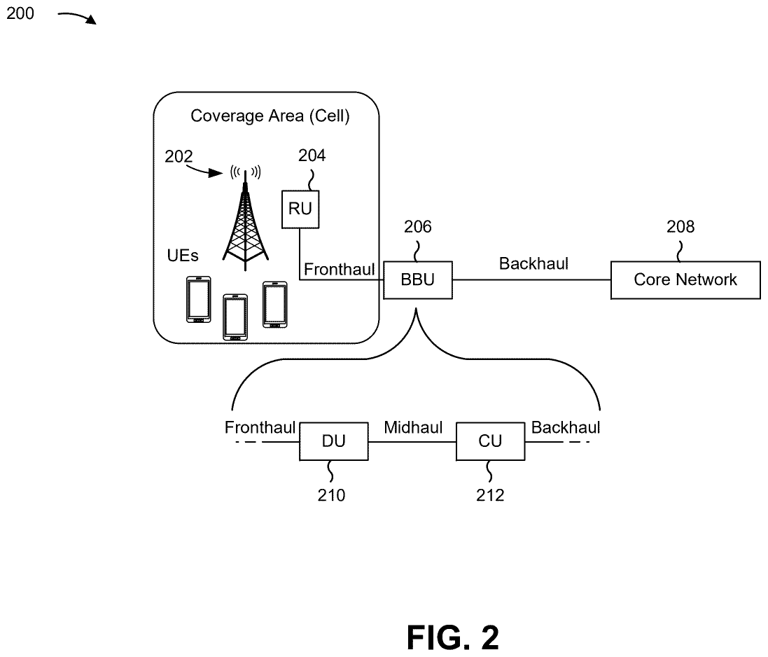

FIG. 2 is a diagram of an example RAN 200 in which systems and/or methods described herein may be implemented. In some implementations, the RAN 200 may be an open RAN (e.g., an O-RAN) and/or a 5G RAN. In some implementations, the RAN 200 may be another type of RAN, including a future generation RAN, such as 6G RAN. The RAN 200 may include an antenna tower 202 (e.g., a cell tower) including one or more antennas. For example, the antenna tower 202 may include one or more antenna arrays, such as one or more massive MIMO arrays. The antenna tower 202 may be configured to transmit and receive signals within a coverage area, sometimes referred to as a cell. Thus, the antenna tower 202 may interact with one or more UEs located within the coverage area. Additionally, the RAN 200 may include an RU 204 (e.g., an O-RU), a BBU 206, and a core network 208. The BBU 206 may include a DU 210 (e.g., an O-DU) and a CU 212 (e.g., an O-CU). The RU 204 may interface with or otherwise communicate with the one or more UEs via the antenna tower 202 (e.g., via the one or more antennas). Thus, the RAN 200 may connect one or more UEs the core network 208.

The RU 204 may perform beamforming and antenna control. For example, the RU 204 may control one or more antenna parameters to support advanced antenna techniques, such as massive MIMO and beamforming for improved signal quality and efficiency. In addition, the RU 204 may perform synchronization. For example, the RU 204 may maintain precise timing for signal transmission and reception, which may be beneficial for the operation of cellular networks.

The RU 204 and the DU 210 may be connected by a fronthaul communication link (e.g., CPRI or eCPRI), for example, for exchanging fronthaul packets (e.g., open fronthaul packets). Uplink data may flow from the RU 204 to the DU 210, and ultimately to the core network 208. Conversely, downlink data may flow from the DU 210 to the RU 204, and ultimately to a UE. In open fronthaul communication, uplink data may be encapsulated as IQ (in-phase and quadrature) data and transmitted over protocols, such as eCPRI, to the DU 210 for further baseband processing.

In addition, the DU 210 and the CU 212 may be connected by a midhaul communication link. The CU 212 may be connected to the core network 208 via a backhaul communication link.

As indicated above, FIG. 2 is provided as an example. Other examples may differ from what is described with regard to FIG. 2. The number and arrangement of devices and components shown in FIG. 2 are provided as an example. In practice, there may be additional devices or components, fewer devices or components, different devices or components, or differently arranged devices or components than those shown in FIG. 2.

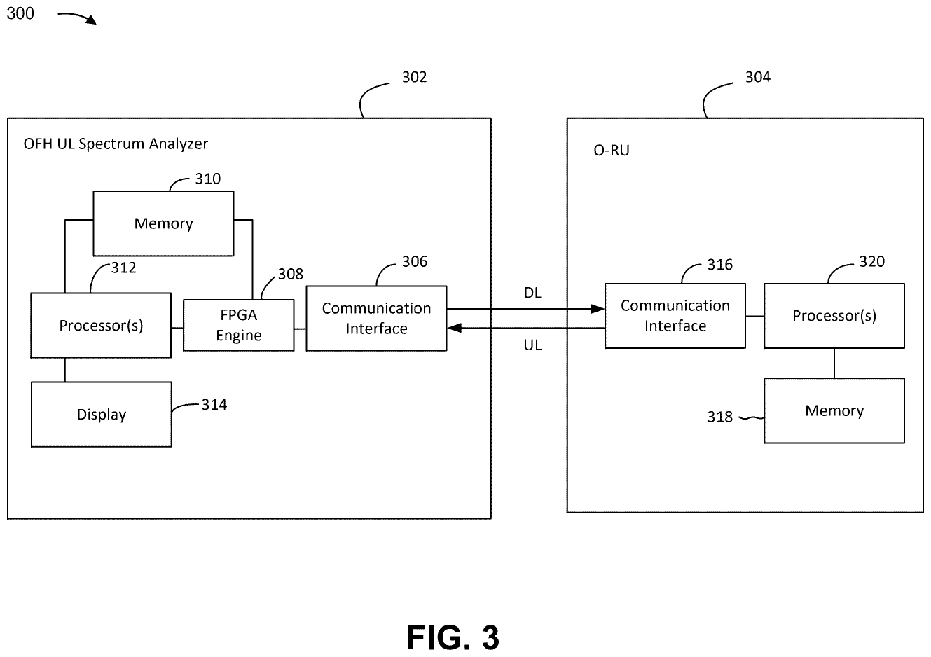

FIG. 3 is a diagram of a spectral analysis system 300 according to one or more implementations. The spectral analysis system 300 may include an OFH UL spectrum analyzer 302 that emulates a subset of functions of an O-DU. The spectral analysis system 300 may also include an O-RU 304. The OFH UL spectrum analyzer 302 and the O-RU 304 may be connected by UL and DL fronthaul communication links, such as eCPRI communication links. In some implementations, the OFH UL spectrum analyzer 302 may include a communication interface 306, a field-programmable gate array (FPGA) engine 308, one or more memories 310, one or more processors 312, and a display 314. In some implementations, the FPGA engine 308 may be substituted with a different type of processing engine. The O-RU 304 may include a communication interface 316, one or more memories 318, and one or more processors 320,

The communication interface 306 of the OFH UL spectrum analyzer 302 may receive UL packets, such as user plane packets, and may extract (e.g., via decoding) frequency-domain IQ data (e.g., pairs of IQ values) that is embedded in the UL packets. Additionally, the communication interface 306 may generate DL packets, such as management plane packets and control plane packets, and transmit the DL packets to the O-RU 304.

The communication interface 316 of the O-RU 304 may receive the DL packets, and may decode the DL packets for processing. Additionally, the communication interface 316 may generate the UL packets, and transmit the UL packets to the OFH UL spectrum analyzer 302. The one or more processors 320 may be communicatively coupled to the one or more memories 318 for processing information provided in the DL packets.

The communication interface 306 may initialize the O-RU 304 with O-RAN management plane messages. Once the O-RU 304 is initialized, the communication interface 306 may transmit, to the O-RU 304, a plurality of control plane packets. Each control plane packet of the plurality of control plane packets may correspond to a respective timeslot of a plurality of timeslots. Thus, the OFH UL spectrum analyzer 302 may transmit control plane messages (e.g., packets) to the O-RU 304 periodically, on a per timeslot basis, to configure the O-RU 304 to send user plane packets. In addition, the communication interface 306 may receive, from the O-RU 304, a plurality of user plane packets for each respective timeslot. Each user plane packet may include a pair of IQ values (e.g., frequency-domain IQ data or frequency-domain UL spectrum data) representative of a respective symbol of a plurality of symbols. In other words, each user plane packet may include a single pair of IQ values. The communication interface 306 may extract the pairs of IQ values from the plurality of user plane packets, and provide the pairs of IQ values to the FPGA engine 308.

The FPGA engine 308 may combine, for each subcarrier of a plurality of subcarriers and for a predetermined number of radio frames, pairs of IQ values into a single IQ value to derive a plurality of single IQ values for the predetermined number of radio frames. For example, the FPGA engine 308 may calculate an average of the pairs of IQ values for a given subcarrier, and may use the average as the single IQ value for the given subcarrier. The FPGA engine 308 may repeat the calculation for each subcarrier, using respective pairs of IQ values to calculate an average value, to derive the plurality of single IQ values for the predetermined number of radio frames (e.g., for the plurality of subcarriers of the radio frames). Thus, each single IQ value of the plurality of single IQ values corresponds to a respective subcarrier of the plurality of subcarriers. The FPGA engine 308 may provide the plurality of single IQ values to the one or more memories 310 or the one or more processors 312 for further processing.

The one or more processors 312 may generate pixel values based on the plurality of single IQ values. Here, the pixel values may be representative of power levels (e.g., amplitudes of an accumulated spectrum) across a frequency axis for a transmission bandwidth of the O-RU 304. In some implementations, each single IQ value is representative of a power level of an accumulated spectrum of a respective subcarrier. The display 314 may display an image of an UL spectrum of the O-RU 304 based on the pixel values.

In some implementations, a frequency-domain resolution is equal to a sub-carrier spacing, and a time-domain resolution is equal to a symbol duration.

In some implementations, a quantity of single IQ values may exceed a quantity of pixels of the display 314. Thus, the single IQ values may be resized in order to accommodate the lower quantity of pixels. For examples, the one or more processors 312 may resize the plurality of single IQ values into a predetermined quantity of pixel values. The predetermined quantity of pixel values may be less than the quantity of single IQ values of the plurality of single IQ values. The one or more processors 312 may apply a linear interpolation filter, such as a triangle filter function, to the plurality of single IQ values to obtain the predetermined quantity of pixel values. The one or more processors 312 may generate the image having the predetermined quantity of pixel values, and cause the display 314 to display the image.

In some implementations, the communication interface 306 may request UL spectrum data from the O-RU 304. The communication interface 306 may initialize the O-RU 304 with O-RAN management plane messages, and transmit control plane messages to the O-RU 304 periodically, on a per timeslot basis, to configure the O-RU 304 to send user plane packets containing the UL spectrum data. Thus, the communication interface 306 may request UL spectrum data for a plurality of timeslots. The UL spectrum data may be frequency-domain IQ data (e.g., pairs of IQ values). The communication interface 306 may receive the UL spectrum data from the O-RU 304. The UL spectrum data may be mapped into the user plane packets. The communication interface 306 may receive all frequency domain IQ data (all symbols) for all RBs in the plurality of timeslots. Thus, the communication interface 306 may extract the UL spectrum data from the user plane packets.

The FPGA engine 308 and the one or more processors 312 may perform a spectral analysis using the UL spectrum data. For example, the FPGA engine 308 may, for each subcarrier of a plurality of subcarriers, combine the frequency domain IQ data into a single IQ value to derive a plurality of single IQ values for the plurality of subcarriers. In some implementations, the FPGA engine 308 may, in order to combine the frequency domain IQ data into a single IQ value, combine the plurality of pairs of IQ values of a given subcarrier into a single IQ value. Accordingly, the FPGA engine 308 may calculate a plurality of single IQ values for the plurality of subcarriers. The plurality of single IQ values may be representative of power levels of the real-time UL spectrum. The one or more processors 312 may generate, based on the plurality of single IQ values, an image of a real-time UL spectrum of the O-RU 304, and cause the display 314 to display the image. Accordingly, the OFH UL spectrum analyzer 302 may perform a direct, real-time spectral analysis of an UL signal received from the O-RU 304.

As indicated above, FIG. 3 is provided as an example. Other examples may differ from what is described with regard to FIG. 3. The number and arrangement of devices and components shown in FIG. 3 are provided as an example. In practice, there may be additional devices or components, fewer devices or components, different devices or components, or differently arranged devices or components than those shown in FIG. 3.

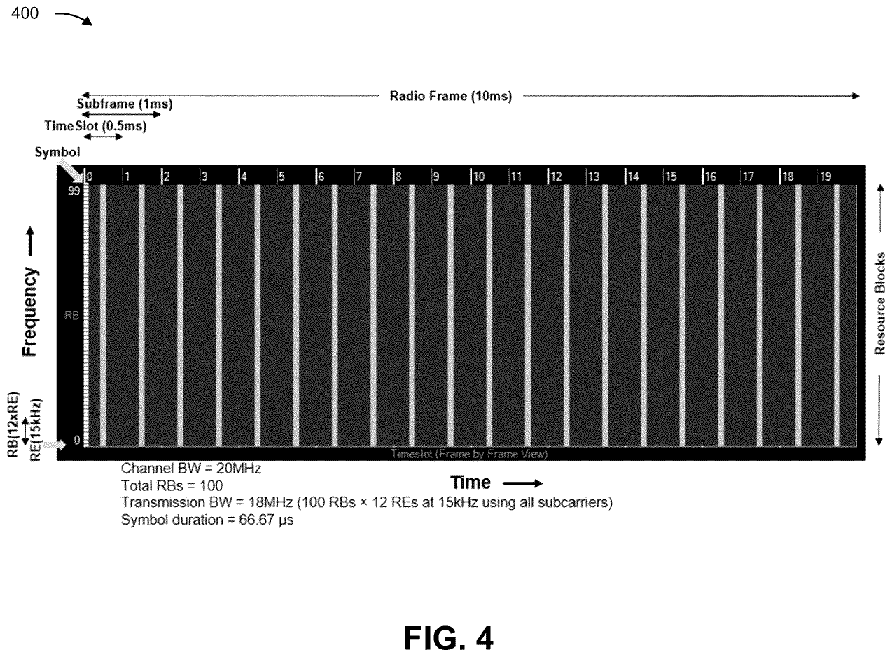

FIG. 4 shows an example UL resource grid 400. The OFH UL spectrum analyzer 302 may display the power levels across the frequency axis within the transmission bandwidth supported by the O-RU 304. The transmission bandwidth, also referred to as occupied bandwidth, is a bandwidth that the OFH link represents. Channel bandwidth includes the transmission bandwidth and guard bands. For example, the transmission bandwidth may be 18 MHz, and the channel bandwidth may be 20 MHz, with each guard band being 1 MHz on opposite sides of the transmission bandwidth. The OFH UL spectrum analyzer 302 may only display the spectrum of the transmission bandwidth.

The transmission bandwidth may be composed of multiple subcarriers. As an example, 15 kHz may represent one subcarrier. Thus, for a transmission bandwidth of 18 MHz, there may be 1,200 subcarriers (e.g., 18 MHz=1200×15 kHz). An LTE signal may be visualized as a resource grid that is composed of a radio frame (10 ms) on the x-axis and RBs on the y-axis. In this example, there are 100 RBs. An RB may include 12 resource elements (REs). An RE represents a single subcarrier and includes a symbol. A symbol may be represented by a pair of IQ values. Thus, in the current example, there may be a total of 1,200 pairs of IQ values for a transmission bandwidth of 18 MHz.

The OFH link carries the pairs of IQ values in user plane packets between the O-RU and the O-DU or the OFH UL spectrum analyzer 302. Control plane packets may provide context for user plane packets. A control plane packet may represent or may be associated with a single timeslot, and be followed by all user plane packets belonging to that timeslot. For example, the OFH UL spectrum analyzer 302 may send a control plane packet that requests the O-RU 304 to transmit all user plane packets belonging to the timeslot associated with the control plane packet. In order to obtain all user plane packets for all timeslots, the OFH UL spectrum analyzer 302 may send a control plane packet for each timeslot. The OFH UL spectrum analyzer 302 may send a next control plane packet for a next timeslot after receiving all user plane packets belonging to the timeslot associated with a previous control plane packet. Each user plane packet may carry the I and Q values for a symbol.

The OFH UL spectrum analyzer 302 may send a control plane packet for each timeslot to the O-RU 304. Upon receiving a control plane packet, the O-RU 304 may return several user plane packets belonging to that timeslot to the OFH UL spectrum analyzer 302. Thus, the OFH UL spectrum analyzer 302 receives all symbols (e.g., all pairs of IQ values) for all requested timeslots.

The FPGA engine 308 may process the pairs of IQ values based on detector type (e.g., positive peak, negative peak, sample, normal, and average). The FPGA engine 308 may combine the pairs of IQ values belonging to each subcarrier (e.g., each RE) across a time axis for a duration of 100 milliseconds (ms). For an LTE signal, 100 ms is composed of 10 radio frames. Each radio frame is 10 ms. In this example, each radio frame contains 140 symbols (e.g., 140 pairs of IQ values). Therefore, in total, the FPGA engine 308 takes the values of 1,400 symbols and combines the values of the 1,400 symbols as a single value (e.g., a single IQ value). In some implementations, the FPGA engine 308 may calculate the single value as an average of the 1,400 symbols. The single value is provided to the one or more memories 310 and/or the one or more processors 312 for further processing. In this example, the one or more processors 312 may receive a single value every 100 ms for a subcarrier (y-axis), or a total of 1,200 (100 RB×12 RE per RB) single values (points) for all subcarriers. The single values may be pixel values representative of the power levels of the UL spectrum, with each single value representing a pixel value of a pixel.

In some implementations, the display may have fewer pixels than the total quantity of single values. For example, a display may have only 801 pixels and there may be 1,200 single values (e.g., initial pixel values). As a result, the one or more processors 312 may resize the 1,200 single values into 801 points or pixels. In order to resize the 1,200 single values into 801 points (e.g., final pixel values), the one or more processors 312 may apply a linear interpolation filter to the single values to obtain a desired quantity of pixel values that can be accommodated by the display 314. In some implementations, the linear interpolation filter may be a triangle filter function. The linear interpolation filter may be used to stretch or scale up the single values. Alternatively, the linear interpolation filter may be used to shrink or scale down the single values. Thus, each single value may be mapped to a pixel of the display 314.

As indicated above, FIG. 4 is provided as an example. Other examples may differ from what is described with regard to FIG. 4.

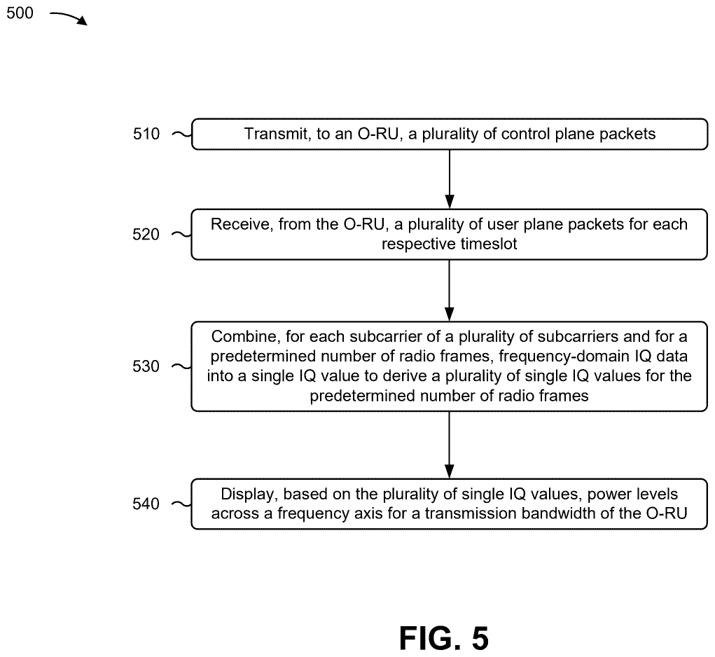

FIG. 5 is a flowchart of an example process 500 associated with uplink spectrum analysis over open fronthaul networks. One or more process blocks of FIG. 5 are performed by an UL spectrum analyzer (e.g., OFH UL spectrum analyzer 302) and/or by another device or a group of devices separate from or including the UL spectrum analyzer, such as an O-RU (e.g., O-RU 304). Additionally, or alternatively, one or more process blocks of FIG. 5 may be performed by one or more components of the UL spectrum analyzer, such as communication interface 306, FPGA engine 308, one or more memories 310, one or more processors 312, and/or display 314.

As shown in FIG. 5, process 500 includes transmitting, to an O-RU, a plurality of control plane packets (block 510). Each control plane packet of the plurality of control plane packets may correspond to a respective timeslot of a plurality of timeslots. For example, the UL spectrum analyzer may transmit, to the O-RU, the plurality of control plane packets (e.g., on a timeslot basis), as described above.

As further shown in FIG. 5, process 500 includes receiving, from the O-RU, a plurality of user plane packets for each respective timeslot (block 520). Each user plane packet may include frequency-domain IQ data representative of a respective symbol of a plurality of symbols. For example, the OFH UL spectrum analyzer 302 may receive, from the O-RU, the plurality of user plane packets for each respective timeslot, as described above.

As further shown in FIG. 5, process 500 includes combining, for each subcarrier of a plurality of subcarriers and for a predetermined number of radio frames, the frequency-domain IQ data into a single IQ value to derive a plurality of single IQ values for the predetermined number of radio frames (block 530). Each single IQ value of the plurality of single IQ values may correspond to a respective subcarrier of the plurality of subcarriers. For example, the OFH UL spectrum analyzer 302 may combine, for each subcarrier of a plurality of subcarriers and for a predetermined number of radio frames, the frequency-domain IQ data into a single IQ value to derive the plurality of single IQ values for the predetermined number of radio frames, as described above.

As further shown in FIG. 5, process 500 includes displaying, based on the plurality of single IQ values, power levels across a frequency axis for a transmission bandwidth of the O-RU (block 540). For example, the OFH UL spectrum analyzer 302 may display, based on the plurality of single IQ values, power levels across a frequency axis for a transmission bandwidth of the O-RU, as described above.

Process 500 may include additional aspects, such as any single aspect or any combination of aspects described below and/or in connection with one or more other processes described elsewhere herein.

In a first aspect, the frequency-domain IQ data includes a pair of IQ values representative of the respective symbol.

In a second aspect, the plurality of single IQ values are pixel values representative of the power levels.

In a third aspect, process 500 includes resizing the plurality of single IQ values into a predetermined number of pixel values, wherein the predetermined number of pixel values is less than a number of single IQ values of the plurality of single IQ values, and displaying the predetermined number of pixel values as an UL spectrum of the O-RU.

In a fourth aspect, resizing the plurality of single IQ values includes applying a linear interpolation filter to the plurality of single IQ values to obtain the predetermined number of pixel values.

In a fifth aspect, the linear interpolation filter is a triangle filter function.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

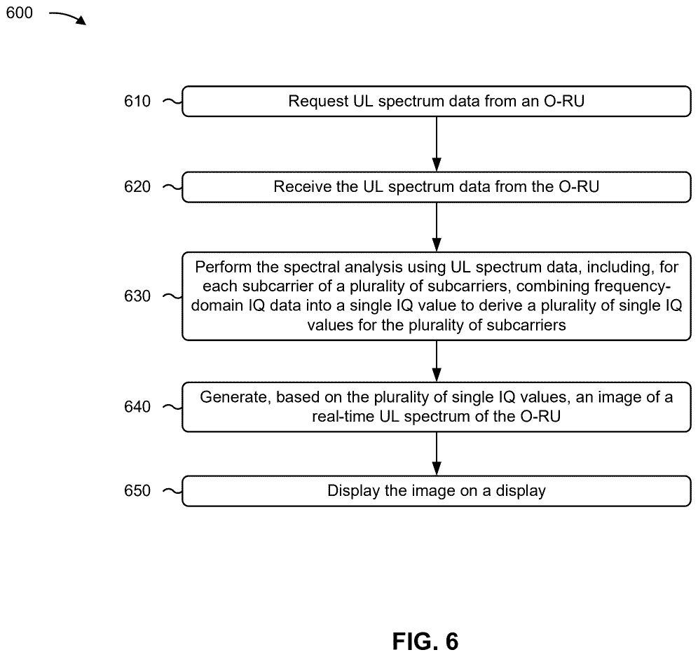

FIG. 6 is a flowchart of an example process 600 associated with uplink spectrum analysis over open fronthaul networks. One or more process blocks of FIG. 6 are performed by an UL spectrum analyzer (e.g., OFH UL spectrum analyzer 302) and/or by another device or a group of devices separate from or including the UL spectrum analyzer, such as an O-RU (e.g., O-RU 304). Additionally, or alternatively, one or more process blocks of FIG. 6 may be performed by one or more components of the UL spectrum analyzer, such as communication interface 306, FPGA engine 308, one or more memories 310, one or more processors 312, and/or display 314.

As shown in FIG. 6, process 600 includes requesting UL spectrum data from an O-RU (block 610). For example, the OFH UL spectrum analyzer 302 may request UL spectrum data from the O-RU, as described above.

As further shown in FIG. 6, process 600 includes receiving the UL spectrum data from the O-RU (block 620). The UL spectrum data may be mapped into user plane packets. Additionally, the UL spectrum data may include frequency-domain IQ data. For example, the OFH UL spectrum analyzer 302 may receive the UL spectrum data from the O-RU, as described above.

As further shown in FIG. 6, process 600 includes performing the spectral analysis using the UL spectrum data, including, for each subcarrier of a plurality of subcarriers, combining the frequency-domain IQ data into a single IQ value to derive a plurality of single IQ values for the plurality of subcarriers (block 630). For example, the OFH UL spectrum analyzer 302 may perform the spectral analysis using the UL spectrum data, as described above.

As further shown in FIG. 6, process 600 includes generating, based on the plurality of single IQ values, an image of a real-time UL spectrum of the O-RU (block 640). For example, the OFH UL spectrum analyzer 302 may generate, based on the plurality of single IQ values, an image of a real-time UL spectrum of the O-RU, as described above.

As further shown in FIG. 6, process 600 includes displaying the image on a display (block 650). For example, the OFH UL spectrum analyzer 302 may display the image on a display, as described above.

Process 600 may include additional aspects, such as any single aspect or any combination of aspects described below and/or in connection with one or more other processes described elsewhere herein.

In a first aspect, the frequency-domain IQ data includes a plurality of pairs of IQ values provided in a frequency-domain, wherein each pair of IQ values of the plurality of pairs of IQ values is representative of a respective symbol of a plurality of symbols, and wherein combining the frequency-domain IQ data into the single IQ value includes for each subcarrier of the plurality of subcarriers, combining the plurality of pairs of IQ values into the single IQ value to derive the plurality of single IQ values for the plurality of subcarriers.

In a second aspect, process 600 includes resizing the plurality of single IQ values into a predetermined quantity of pixel values, wherein the predetermined quantity of pixel values is less than a quantity of single IQ values of the plurality of single IQ values, and displaying the pixel values with the predetermined quantity of pixel values as the image.

In a third aspect, displaying the real-time UL spectrum includes resizing the plurality of single IQ values using a linear interpolation filter to generate pixel values of the image.

In a fourth aspect, the spectral analysis is a direct, real-time spectral analysis.

In a fifth aspect, requesting UL spectrum data includes requesting UL spectrum data for a plurality of timeslots, and receiving the UL spectrum data includes receiving all frequency-domain IQ data for all resource blocks in the plurality of timeslots.

In a sixth aspect, process 600 includes initializing the O-RU with O-RAN management plane messages, transmitting control plane messages to the O-RU periodically, on a per timeslot basis, to configure the O-RU to send the user plane packets, the user plane packets containing the frequency-domain IQ data, extracting the frequency-domain IQ data from the user plane packets, and calculating the plurality of single IQ values based on the frequency-domain IQ data, wherein the plurality of single IQ values are representative of power levels of the real-time UL spectrum.

In a seventh aspect, a frequency-domain resolution is equal to a sub-carrier spacing, and a time-domain resolution is equal to a symbol duration.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:
Aspect 1: A method for performing spectral analysis on open fronthaul (OFH) uplink (UL) packets of an open radio access network (O-RAN), the method comprising: transmitting, to an open radio unit (O-RU), a plurality of control plane packets, wherein each control plane packet of the plurality of control plane packets corresponds to a respective timeslot of a plurality of timeslots; receiving, from the O-RU, a plurality of user plane packets for each respective timeslot, wherein each user plane packet includes frequency-domain in-phase and quadrature (IQ) data representative of a respective symbol of a plurality of symbols; combining, for each subcarrier of a plurality of subcarriers and for a predetermined number of radio frames, the frequency-domain IQ data into a single IQ value to derive a plurality of single IQ values for the predetermined number of radio frames, wherein each single IQ value of the plurality of single IQ values corresponds to a respective subcarrier of the plurality of subcarriers; and displaying, based on the plurality of single IQ values, power levels across a frequency axis for a transmission bandwidth of the O-RU.
Aspect 2: The method of Aspect 1, wherein the frequency-domain IQ data includes a pair of IQ values representative of the respective symbol.
Aspect 3: The method of any of Aspects 1-2, wherein the plurality of single IQ values are pixel values representative of the power levels.
Aspect 4: The method of any of Aspects 1-3, further comprising: resizing the plurality of single IQ values into a predetermined number of pixel values, wherein the predetermined number of pixel values is less than a number of single IQ values of the plurality of single IQ values; and displaying the predetermined number of pixel values as an UL spectrum of the O-RU.
Aspect 5: The method of Aspect 4, wherein resizing the plurality of single IQ values includes applying a linear interpolation filter to the plurality of single IQ values to obtain the predetermined number of pixel values.
Aspect 6: The method of Aspect 5, wherein the linear interpolation filter is a triangle filter function.
Aspect 7: A method for performing spectral analysis on open fronthaul (OFH) uplink (UL) packets of an open radio access network (O-RAN), the method comprising: requesting UL spectrum data from an open radio unit (O-RU); receiving the UL spectrum data from the O-RU, wherein the UL spectrum data is mapped into user plane packets, and wherein the UL spectrum data comprises frequency-domain in-phase and quadrature (IQ) data; performing the spectral analysis using the UL spectrum data, including: for each subcarrier of a plurality of subcarriers, combining the frequency-domain IQ data into a single IQ value to derive a plurality of single IQ values for the plurality of subcarriers; generating, based on the plurality of single IQ values, an image of a real-time UL spectrum of the O-RU; and displaying the image on a display.
Aspect 8: The method of Aspect 7, wherein the frequency-domain IQ data includes a plurality of pairs of IQ values provided in a frequency-domain, wherein each pair of IQ values of the plurality of pairs of IQ values is representative of a respective symbol of a plurality of symbols, and wherein combining the frequency-domain IQ data into the single IQ value includes: for each subcarrier of the plurality of subcarriers, combining the plurality of pairs of IQ values into the single IQ value to derive the plurality of single IQ values for the plurality of subcarriers.
Aspect 9: The method of any of Aspects 7-8, further comprising: resizing the plurality of single IQ values into a predetermined quantity of pixel values, wherein the predetermined quantity of pixel values is less than a quantity of single IQ values of the plurality of single IQ values; and displaying the pixel values with the predetermined quantity of pixel values as the image.
Aspect 10: The method of any of Aspects 7-9, wherein displaying the real-time UL spectrum includes resizing the plurality of single IQ values using a linear interpolation filter to generate pixel values of the image.
Aspect 11: The method of any of Aspects 7-10, wherein the spectral analysis is a direct, real-time spectral analysis.
Aspect 12: The method of any of Aspects 7-11, wherein requesting UL spectrum data includes requesting UL spectrum data for a plurality of timeslots, and receiving the UL spectrum data includes receiving all frequency-domain IQ data for all resource blocks in the plurality of timeslots.
Aspect 13: The method of any of Aspects 7-12, further comprising: initializing the O-RU with O-RAN management plane messages; transmitting control plane messages to the O-RU periodically, on a per timeslot basis, to configure the O-RU to send the user plane packets, the user plane packets containing the frequency-domain IQ data; extracting the frequency-domain IQ data from the user plane packets; and calculating the plurality of single IQ values based on the frequency-domain IQ data, wherein the plurality of single IQ values are representative of power levels of the real-time UL spectrum.
Aspect 14: The method of any of Aspects 7-13, wherein a frequency-domain resolution is equal to a sub-carrier spacing, and wherein a time-domain resolution is equal to a symbol duration.
Aspect 15: An open fronthaul (OFH) uplink (UL) spectrum analyzer, comprising: a communication interface configured to communicate with an open radio unit (O-RU), the communication interface configured to: transmit, to the O-RU, a plurality of control plane packets, wherein each control plane packet of the plurality of control plane packets corresponds to a respective timeslot of a plurality of timeslots, and receive, from the O-RU, a plurality of user plane packets for each respective timeslot, wherein each user plane packet includes a pair of in-phase and quadrature (IQ) values representative of a respective symbol of a plurality of symbols; one or more memories; one or more processors, communicatively coupled to the one or more memories, configured to: combine, for each subcarrier of a plurality of subcarriers and for a predetermined number of radio frames, pairs of IQ values into a single IQ value to derive a plurality of single IQ values for the predetermined number of radio frames, wherein each single IQ value of the plurality of single IQ values corresponds to a respective subcarrier of the plurality of subcarriers, and generate pixel values based on the plurality of single IQ values, the pixel values being representative of power levels across a frequency axis for a transmission bandwidth of the O-RU; and a display configured to display an image of an UL spectrum of the O-RU based on the pixel values.
Aspect 16: The OFH UL spectrum analyzer of Aspect 15, wherein the one or more processors include: a field-programmable gate array (FPGA) engine configured to combine, for each subcarrier of the plurality of subcarriers and for the predetermined number of radio frames, the pairs of IQ values into the single IQ value to derive the plurality of single IQ values for the predetermined number of radio frames, and at least one processor configured to generate the pixel values.
Aspect 17: The OFH UL spectrum analyzer of any of Aspects 15-16, wherein each single IQ value is representative of a power level of an accumulated spectrum of the respective subcarrier.
Aspect 18: The OFH UL spectrum analyzer of any of Aspects 15-17, wherein the one or more processors are configured to: resize the plurality of single IQ values into a predetermined quantity of pixel values, wherein the predetermined quantity of pixel values is less than a quantity of single IQ values of the plurality of single IQ values; generate the image having the predetermined quantity of pixel values; and cause the display to display the image.
Aspect 19: The OFH UL spectrum analyzer of Aspect 18, wherein the one or more processors are configured to: apply a linear interpolation filter to the plurality of single IQ values to obtain the predetermined quantity of pixel values.
Aspect 20: The OFH UL spectrum analyzer of any of Aspects 15-19, wherein the pair of IQ values in each user plane packet is frequency-domain UL spectrum data.
Aspect 21: A system configured to perform one or more operations recited in one or more of Aspects 1-20.
Aspect 22: An apparatus comprising means for performing one or more operations recited in one or more of Aspects 1-20.
Aspect 23: A non-transitory computer-readable medium storing a set of instructions, the set of instructions comprising one or more instructions that, when executed by a device, cause the device to perform one or more operations recited in one or more of Aspects 1-20.
Aspect 24: A computer program product comprising instructions or code for executing one or more operations recited in one or more of Aspects 1-20.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method for performing spectral analysis on open fronthaul (OFH) uplink (UL) packets of an open radio access network (O-RAN), the method comprising:
transmitting, to an open radio unit (O-RU), a plurality of control plane packets, wherein each control plane packet of the plurality of control plane packets corresponds to a respective timeslot of a plurality of timeslots;
receiving, from the O-RU, a plurality of user plane packets for each respective timeslot, wherein each user plane packet includes frequency-domain in-phase and quadrature (IQ) data representative of a respective symbol of a plurality of symbols;
combining, for each subcarrier of a plurality of subcarriers and for a predetermined number of radio frames, the frequency-domain IQ data into a single IQ value to derive a plurality of single IQ values for the predetermined number of radio frames, wherein each single IQ value of the plurality of single IQ values corresponds to a respective subcarrier of the plurality of subcarriers; and
displaying, based on the plurality of single IQ values, power levels across a frequency axis for a transmission bandwidth of the O-RU.

2. The method of claim 1, wherein the frequency-domain IQ data includes a pair of IQ values representative of the respective symbol.

3. The method of claim 1, wherein the plurality of single IQ values are pixel values representative of the power levels.

4. The method of claim 1, further comprising:
resizing the plurality of single IQ values into a predetermined number of pixel values, wherein the predetermined number of pixel values is less than a number of single IQ values of the plurality of single IQ values; and
displaying the predetermined number of pixel values as an UL spectrum of the O-RU.

5. The method of claim 4, wherein resizing the plurality of single IQ values includes applying a linear interpolation filter to the plurality of single IQ values to obtain the predetermined number of pixel values.

6. The method of claim 5, wherein the linear interpolation filter is a triangle filter function.

7. A method for performing spectral analysis on open fronthaul (OFH) uplink (UL) packets of an open radio access network (O-RAN), the method comprising:
requesting UL spectrum data from an open radio unit (O-RU);
receiving the UL spectrum data from the O-RU, wherein the UL spectrum data is mapped into user plane packets, and wherein the UL spectrum data comprises frequency-domain in-phase and quadrature (IQ) data;
performing the spectral analysis using the UL spectrum data, including:
for each subcarrier of a plurality of subcarriers, combining the frequency-domain IQ data into a single IQ value to derive a plurality of single IQ values for the plurality of subcarriers;
generating, based on the plurality of single IQ values, an image of a real-time UL spectrum of the O-RU; and
displaying the image on a display.

8. The method of claim 7, wherein the frequency-domain IQ data includes a plurality of pairs of IQ values provided in a frequency-domain,
wherein each pair of IQ values of the plurality of pairs of IQ values is representative of a respective symbol of a plurality of symbols, and
wherein combining the frequency-domain IQ data into the single IQ value includes:
for each subcarrier of the plurality of subcarriers, combining the plurality of pairs of IQ values into the single IQ value to derive the plurality of single IQ values for the plurality of subcarriers.

9. The method of claim 7, further comprising:
resizing the plurality of single IQ values into a predetermined quantity of pixel values, wherein the predetermined quantity of pixel values is less than a quantity of single IQ values of the plurality of single IQ values; and
displaying the pixel values with the predetermined quantity of pixel values as the image.

10. The method of claim 7, wherein displaying the real-time UL spectrum includes resizing the plurality of single IQ values using a linear interpolation filter to generate pixel values of the image.

11. The method of claim 7, wherein the spectral analysis is a direct, real-time spectral analysis.

12. The method of claim 7, wherein requesting UL spectrum data includes requesting UL spectrum data for a plurality of timeslots, and
receiving the UL spectrum data includes receiving all frequency-domain IQ data for all resource blocks in the plurality of timeslots.

13. The method of claim 7, further comprising:
initializing the O-RU with O-RAN management plane messages;
transmitting control plane messages to the O-RU periodically, on a per timeslot basis, to configure the O-RU to send the user plane packets, the user plane packets containing the frequency-domain IQ data;
extracting the frequency-domain IQ data from the user plane packets; and
calculating the plurality of single IQ values based on the frequency-domain IQ data, wherein the plurality of single IQ values are representative of power levels of the real-time UL spectrum.

14. The method of claim 7, wherein a frequency-domain resolution is equal to a sub-carrier spacing, and
wherein a time-domain resolution is equal to a symbol duration.

15. An open fronthaul (OFH) uplink (UL) spectrum analyzer, comprising:
a communication interface configured to communicate with an open radio unit (O-RU), the communication interface configured to:
transmit, to the O-RU, a plurality of control plane packets, wherein each control plane packet of the plurality of control plane packets corresponds to a respective timeslot of a plurality of timeslots, and
receive, from the O-RU, a plurality of user plane packets for each respective timeslot, wherein each user plane packet includes a pair of in-phase and quadrature (IQ) values representative of a respective symbol of a plurality of symbols;
one or more memories;
one or more processors, communicatively coupled to the one or more memories, configured to:
combine, for each subcarrier of a plurality of subcarriers and for a predetermined number of radio frames, pairs of IQ values into a single IQ value to derive a plurality of single IQ values for the predetermined number of radio frames, wherein each single IQ value of the plurality of single IQ values corresponds to a respective subcarrier of the plurality of subcarriers, and
generate pixel values based on the plurality of single IQ values, the pixel values being representative of power levels across a frequency axis for a transmission bandwidth of the O-RU; and
a display configured to display an image of an UL spectrum of the O-RU based on the pixel values.

16. The OFH UL spectrum analyzer of claim 15, wherein the one or more processors include:
a field-programmable gate array (FPGA) engine configured to combine, for each subcarrier of the plurality of subcarriers and for the predetermined number of radio frames, the pairs of IQ values into the single IQ value to derive the plurality of single IQ values for the predetermined number of radio frames, and
at least one processor configured to generate the pixel values.

17. The OFH UL spectrum analyzer of claim 15, wherein each single IQ value is representative of a power level of an accumulated spectrum of the respective subcarrier.

18. The OFH UL spectrum analyzer of claim 15, wherein the one or more processors are configured to:
resize the plurality of single IQ values into a predetermined quantity of pixel values, wherein the predetermined quantity of pixel values is less than a quantity of single IQ values of the plurality of single IQ values;
generate the image having the predetermined quantity of pixel values; and
cause the display to display the image.

19. The OFH UL spectrum analyzer of claim 18, wherein the one or more processors are configured to:
apply a linear interpolation filter to the plurality of single IQ values to obtain the predetermined quantity of pixel values.

20. The OFH UL spectrum analyzer of claim 15, wherein the pair of IQ values in each user plane packet is frequency-domain UL spectrum data.
